(19) United States
(12) Patent Application Publication
(10) Pub. No.: US 2011/0236865 A1
(43) Pub. Date: Sep. 29, 2011

(54) DEVICE WITH PRE-PRINTED BIBLE SCRIPTURE

(76) Inventor: MARIA PATRICK, Tustin, CA (US)

(21) Appl. No.: 12/748,034

(22) Filed: Mar. 26, 2010

(51) Int. Cl. G09B 19/00

(52) U.S. Cl. 434/245

(57) ABSTRACT

The invention is a device according to the present invention may comprise a medium with rectangular straight edges and a re-adhesive coating on the rear surface, a Bible scripture pre-printed on the front surface of the medium, a particular color of the medium correlating to a theme referenced, taught or discussed in the Bible, and Bible scriptures grouped together based on the color of the medium.

### TECHNICAL FIELD OF THE INVENTION

The present invention relates in general to a device assisting in accelerating the learning of the Bible as well as providing guidance and inspiration through Bible scriptures, and more specifically, to a device with pre-printed Bible scripture.

### COPYRIGHT & TRADEMARK NOTICE

A portion of the disclosure of this patent application may contain material that is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and shall not be construed as descriptive or to limit the scope of this invention to material associated only with such marks.

### BACKGROUND OF THE INVENTION

The Bible is a sacred religious text to many people around the world, especially to those who practice Christianity. In today's fast-paced lifestyle people do not always have the time to effectively read, learn and/or memorize the teachings contained in the Bible.

The Bible is often studied to understand the themes and teachings written in it. Those who have studied the Bible often find passages that inspire them or provide an uplifting message. These messages provide inspiration or guidance in one's daily life. Often, to find a favorite or uplifting passage a person has to read the entire Bible to look up a particular passage. Once the passage is found one must immediately memorize it or write it on a piece of paper. However, loose sheets of paper are often lost or thrown out to minimize clutter without realizing what is on the paper. If the paper the passage is written on is properly stored, it is usually stored where it is not readily accessible.

Currently there are many devices in the market that provide a method for learning, yet no such product exists that is specifically tailored to teaching passages from the Bible effectively. Most products in the art provide a blank sheet of paper to provide the student an area to write a passage. However, the paper is usually filed in a place not easily accessible and is out of sight.

Other products such as books of Bible verses streamline the Bible reading and learning process by picking out and highlighting meaningful verses and placing them in a convenient outline. One drawback, however, is that Bible-verse books require a reader's undivided attention reading and learning bibles verses. Such products cease to be effective once one decides to work on something else. They also take away from time that one could be reading the Bible itself.

Greeting cards are also available with Bible verses printed on them. However, these products are intended to convey thanks or a particular feeling. In addition, these products take up space on desk tops and are often flimsy so that they are constantly falling over. Due to the flimsiness of the card to stand upright, they are not ideal for displaying scriptures from the Bible. Thus, they provide a limited reflection of the learning experience or inspiration and/or guidance.

People who feel depressed, helpless or frustrated turn to the Bible for comfort and inspiration. One population that benefits from the teachings of the Bible are those incarcerated in jails and prisons. Often times, incarceration facilities prohibit friends and families from physically giving Bibles to those in jail or prison.

The current products of teaching the Bible are only marginally conducive to accelerating the learning process of the teachings in the Bible. Further, these products lack the ability to provide inspiration on a daily basis. There is a need in the art for a learning device for Bible scriptures that effectively helps to accelerate the learning process beyond just reading the Bible. There is also a need in the art for a product that provides daily, if not constant, inspiration or guidance from the Bible. It is to these ends that the present invention has been developed.

### SUMMARY OF THE INVENTION

To minimize the limitations in the prior art, and to minimize other limitations that will be apparent upon reading and understanding the present specification, the present invention describes a device with pre-printed Bible scripture.

A device according to the present invention may comprise a medium with generally rectangular straight edges, a front surface with a pre-printed Bible scripture, and a back surface with a re-adhesive coating. Each color of the device corresponds to a particular theme.

Additionally, a plurality of devices of the same theme grouped in a device pad according to the present invention may comprise a plurality of a medium, a pre-printed Bible scripture on the front surface of each medium and a back surface with re-adhesive coating on each medium. Each device pad is a particular color based a specific theme.

Additionally, a plurality of device pads stacked together according to the present invention may comprise a plurality of pads, a pre-printed Bible scripture on the front surface of each medium, a back surface with a re-adhesive coating on each medium, and a medium of various colors correlating to a theme.

It is an objective of the present invention to accelerate the process of learning and memorization of the Bible.

It is another objective of the present invention to place the device on an object that one will see daily to provide inspiration or guidance.

It is another objective of the present invention to place a device in the Bible to mark the location of one's favorite Bible scripture or chapter.

It is another objective of the present invention to group the device of Bible scriptures of the same theme by printing the scripture on the same color device.

Finally, it is yet another objective of the present invention to provide a learning device for the Bible for those are who are incarcerated.

These and other advantages and features of the present invention are described herein with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 is a front perspective view of an exemplary embodiment of the present invention depicting a device with a pre-printed Bible scripture.

FIG. 2 is a rear perspective view of an exemplary embodiment of the present invention depicting a device with a pre-printed Bible scripture.

FIG. 3 is a front perspective view of an exemplary embodiment of the present invention depicting a device pad of the device with a pre-printed Bible scripture.

FIG. 4 is a front perspective view of an exemplary embodiment of the present invention depicting a device stack of the device with a pre-printed Bible scripture.

FIG. 5(a) is a front perspective view of an alternative embodiment of the present invention depicting a device with a pre-printed Bible scripture.

FIG. 5(b) is a front perspective view of an alternative embodiment of the present invention depicting a device with a pre-printed Bible scripture.

FIG. 6 is a front perspective view of an exemplary embodiment of the present invention depicting a pad of the device with a pre-printed Bible scripture.

### DETAILED DESCRIPTION OF THE DRAWINGS

In the following discussion that addresses a number of embodiments and applications of the present invention, reference is made to the accompanying drawings that form a part hereof, where depictions are made, by way of illustration, of specific embodiments in which the invention may be practiced. It is to be understood that other embodiments may be utilized and changes may be made without departing from the scope of the present invention.

The Bible is a sacred religious text, principally to those who practice Christianity and Judaism. The present invention relates only to the Bible as central text to Christianity. The Christian Bible is composed of the “Old Testament” and the “New Testament”.

The Old Testament, likely written between the 14^{th} and 5^{th} centuries B.C.E. in Hebrew with some portions written in Aramaic, adopted the Hebrew Bible into its cannon. The Old Testament consists of prophetic and ethical teachings, as well as the historic account of the Israelites. However, contents of the Old Testament vary depending on the type of Christianity practiced. The Old Testament and the Hebrew Bible themselves are distinguished in the order of the books contained therein. For example, the Hebrew Bible ends with the Book of Chronicles. In contrast, in the Old Testament the Book of Malachi is placed last so the prophesy of the coming of the Messiah leads into the birth of Christ in the Gospel of Matthew in the New Testament.

The New Testament was written by various authors sometime after A.D. 45. The original text was likely written in Koine Greek and consists of the four narratives of the life and death of Jesus called “Gospels,” a narrative of the Apostles' ministries in the early church, twenty-one early letters commonly called “epistles,” and an apocalyptic prophecy.

Throughout history the Bible has been translated into many different languages. Initially, the Old Testament was translated into Greek. However, both the Old and New Testament were later translated into Syriac, Coptic, Ge'ez and Latin, among other languages.

Today, the marketplace has a variety of Bibles printed in English. Among them are the New International Version, the King James Version, the New King James Version, the New Living Translation, the Holman Christian Standard Bible, the Amplified Bible and the English Standard Version, just to name a few.

In addition, history has shown that people have looked to the Bible when they are suffering through a time of sorrow, depression, or helplessness. Even in today's modern society, this is still the case.

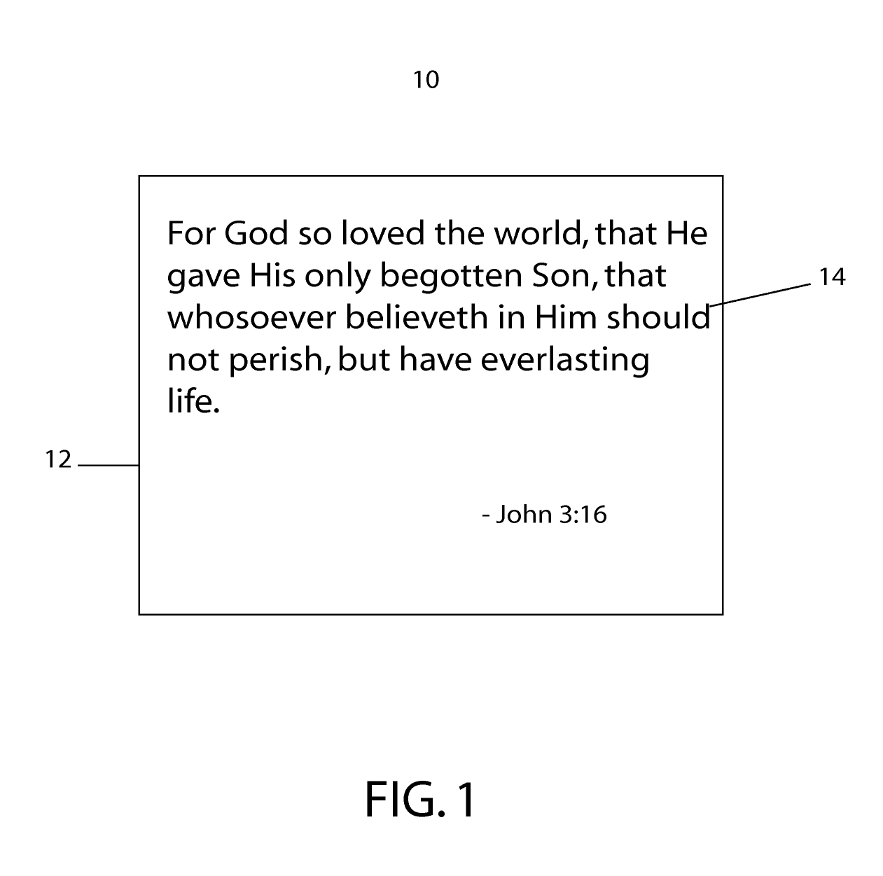

As set forth above, FIG. 1 is a front perspective view of an exemplary embodiment of the present invention depicting device with pre-printed Bible scripture according to the invention.

In the exemplary embodiment, medium 12 may be comprised of a paper material. Medium 12 should be capable of being printed on and retaining the printed material for a sufficient duration of time.

In another exemplary embodiment, medium 12 may also be comprised of natural and synthetic material, including but not limited to, plastic film, and thin, flexible plastic sheets.

Device 10 also contains Bible scripture 14 that quotes text from the Bible that references, teaches or discusses a particular theme. Bible scripture 14 includes a reference noting the Bible's chapter and verse. In addition, themes addressed in Bible scripture 14 may include the following categories: (1) healing, (2) salvation, (3) peace, (4) protection, (5) provision, (6) guidance and (7) promises. This list is not exhaustive of the themes Bible scripture 14 may quote.

Medium 12 of device 10 is not limited to a particular color. In fact, medium 12 may come in a plurality of colors. In such embodiments, each color may represent one of the themes referenced above. Bible scripture 14 corresponds to the color based on the theme of the text.

As a way of illustration, without limiting the scope of the present invention, the theme of healing may be represented on a blue medium 12. Each Bible scripture 14 referencing, teaching or discussing healing would be pre-printed on blue medium 12. In another illustration, the theme of salvation may be represented on yellow medium 12. Each Bible scripture 14 referencing, teaching or discussing salvation would be pre-printed on yellow medium 12. The colors and themes in the above illustration are used only to represent one possible embodiment of the present invention.

Medium 12 may comprise a particular color and include a pictorial imagery. In an exemplary embodiment the pictorial imagery may depict a particular scene in the Bible which Bible scripture 14 references. In another embodiment, the pictorial image may provide an image that enhances and/or reinforces the theme of the text in Bible scripture 14. Bible scripture 14 may be printed over the pictorial imagery to create a background. In yet another embodiment Bible scripture 14 may be printed alongside imagery depicting a scene from the Bible.

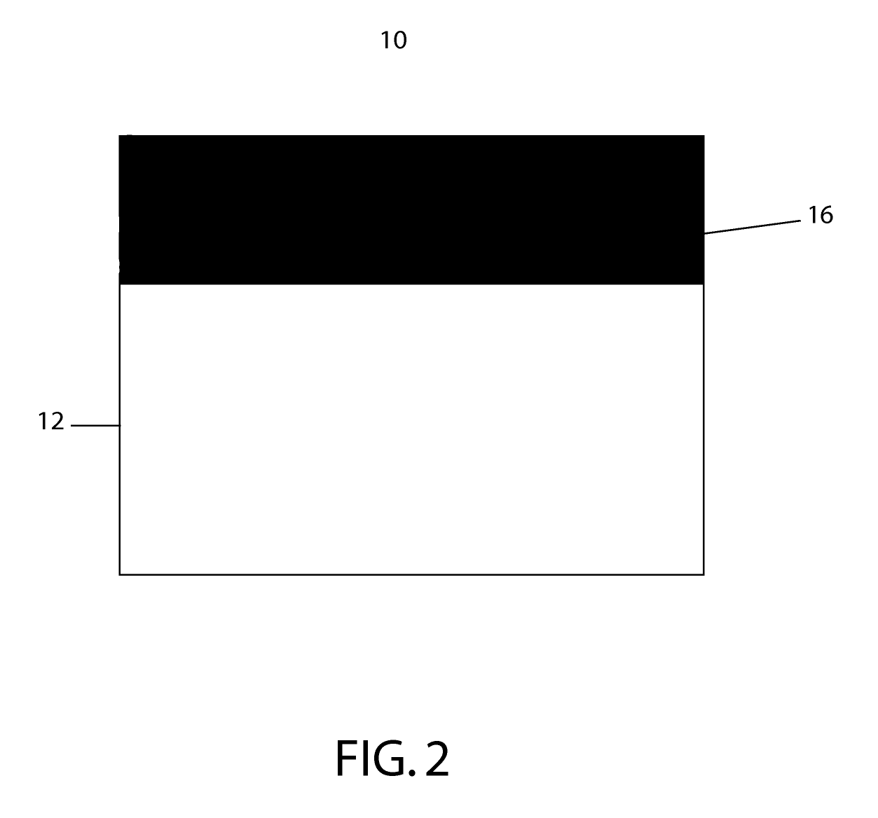

FIG. 2 is a rear perspective view of an exemplary embodiment of the present invention depicting a device with pre-printed Bible scripture.

In an exemplary embodiment, re-adhesive coating 16 allows device 10 to be attached to an object that one desires Bible scripture 14 to be visible. Re-adhesive coating 16 allows device 10 to be adhered to different objects as one sees fit. In an exemplary embodiment re-adhesive coating 16 is on the upper region of the rear side of device 10. The entire rear side of device 10 is blank, without text or imagery. In another exemplary embodiment re-adhesive coating 16 covers the complete read side of device 10.

Re-adhesive coating 16 allows one to attach device 10 in a location that is conducive to inspiration or learning passages from the Bible. As a way of illustration, without limiting the scope of the present invention, one may attach device 10 in one's house. More specifically, one may attach device 10 on to a mirror, refrigerator, closet door, home desktop computer monitor. One may read Bible scripture 14 first thing in the morning, before leaving one's house or in one's normal daily routine.

In another illustration, without limiting the scope of the present invention, one may attach device 10 in one's work or place of business. More specifically, one may attach device 10 to one's work computer monitor, work desk, daily schedule book or other objects around the work area so that Bible scripture 14 is constantly within view. The possibilities of attaching device 10 to any object are vast due to re-adhesive coating 16.

In yet another illustration, without limiting the scope of the present invention, one may attach device 10 to a page in the Bible. More specifically, one may attach device 10 onto the page in the Bible where Bible scripture 14 is located. This provides a bookmark so that one may quickly go to that passage in the Bible. Any additional notes one may wish to write about the passage may be written on device 10.

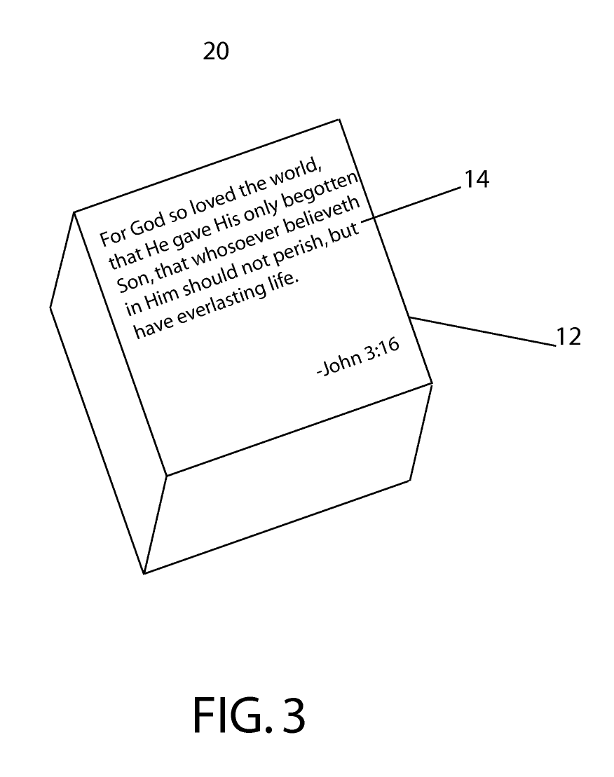

FIG. 3 shows a front perspective view of an exemplary embodiment of the present invention depicting a device pad of the device with a pre-printed Bible scripture.

In an exemplary embodiment, device pad 20 is created by a plurality of devices 10. Device pad 20 may be a uniform color since each Bible scripture 14 in device pad 20 references, teaches or discusses the same theme. As a way of illustration, without limiting the scope of the invention, device pad 20 may be blue because all Bible scripture 14 contained in device pad 20 references, teaches or discusses the theme of healing. In another illustration, device pad 20 may be yellow because all Bible scripture 14 contained in device pad 20 references, teaches, or discusses the theme of salvation. The colors and themes in the above illustration are used only to represent one possible embodiment of the present invention.

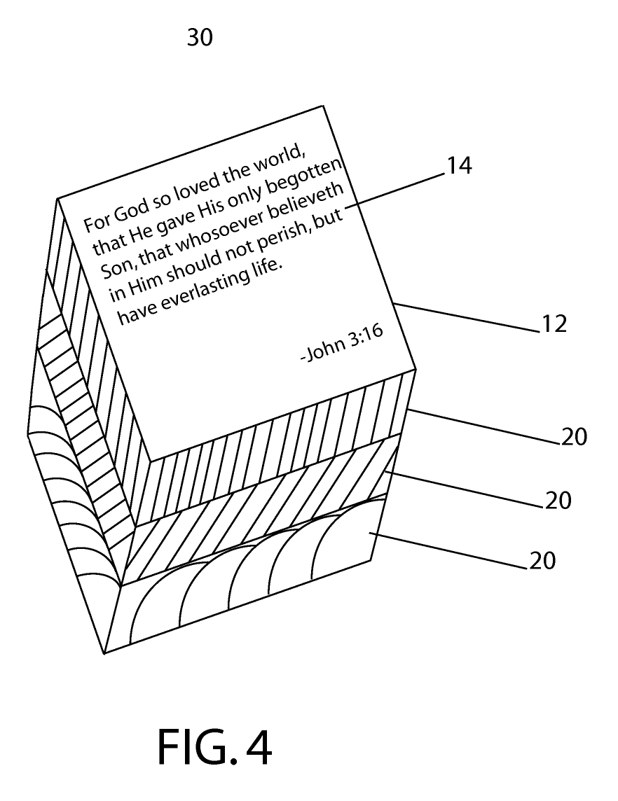

FIG. 4 illustrates is a front perspective view of an exemplary embodiment of the present invention depicting a device stack of the device with a pre-printed Bible scripture.

In an exemplary embodiment, a plurality of devices 10 containing a plurality Bible scriptures 14 of the same theme grouped together to form a device stack 30. Each device 10 includes Bible scripture 14 pre-printed on the front side. The various shading on the sides of device stack 30 represent a device pad 20 of a particular theme which Bible scripture 14 references, teaches or discusses. The plurality of device pads 20 are different colors to correspond to particular themes referenced, taught or discussed in Bible scripture 14.

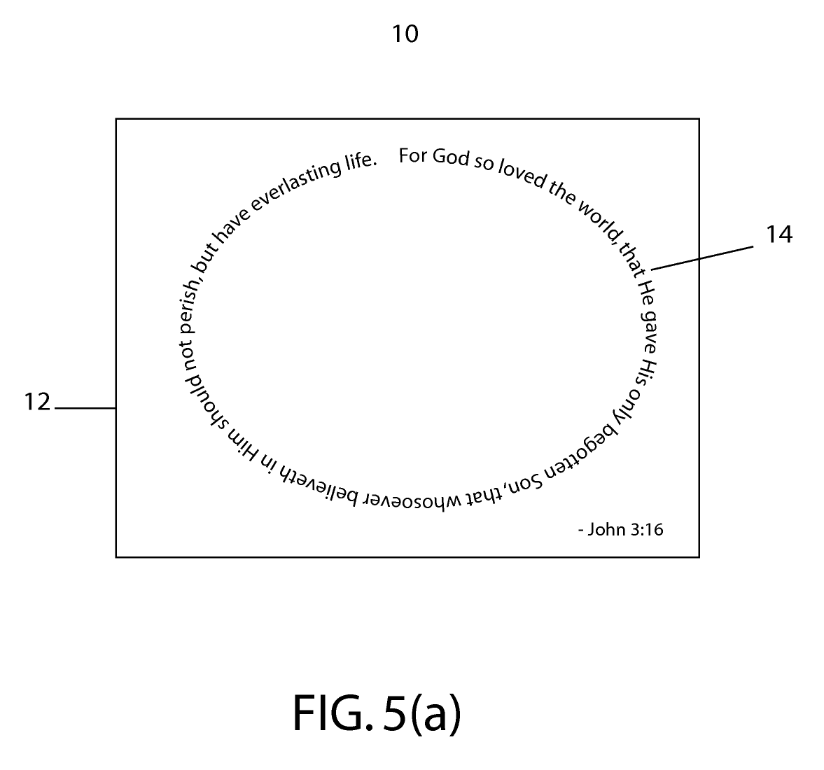

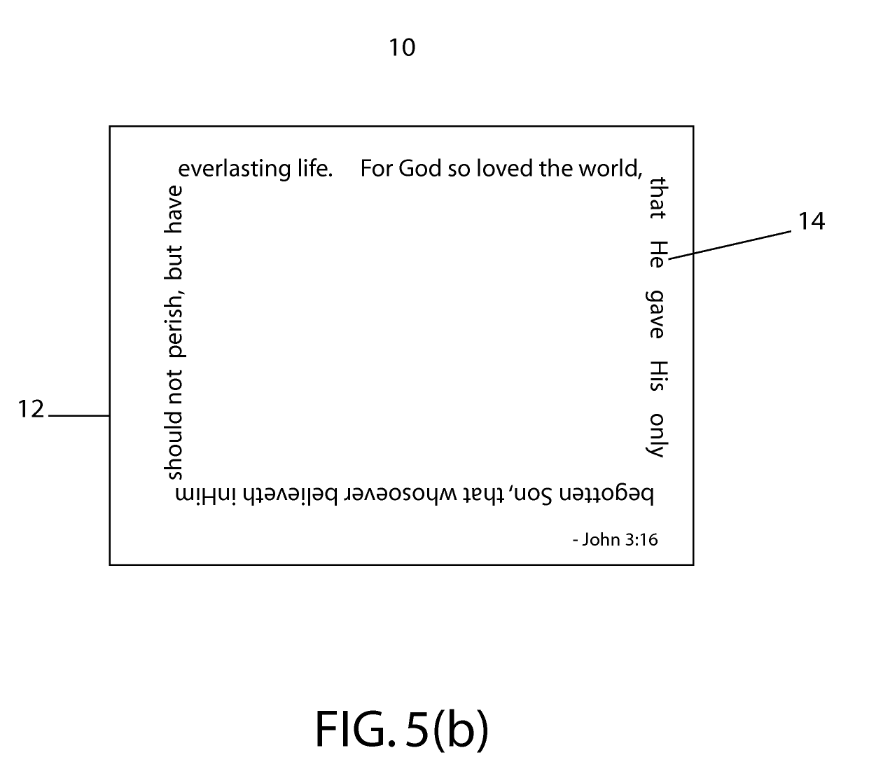

Moving to the next figure, FIG. 5(a) is a front perspective view of an alternative embodiment of the present invention depicting device with pre-printed Bible scripture according to the invention in a pre-formed shape.

In an alternative embodiment of device 10, Bible scripture 14 may be pre-printed onto medium 12 to create a border. More specifically, the border would be in a continuous curved path pattern along the front side of the inner edge of medium 12. In another embodiment, pictorial images may also be pre-printed on medium 12 where the border encircles pictorial image.

FIG. 5(b) is another alternative embodiment of device 10, Bible scripture 14 may be pre-printed in a rectangular path mirroring the front side of the inner edge of medium 12. In another embodiment, the border created by Bible scripture 14 may surround a pictorial image in the center of medium 12. The pictorial image may depict a scene from the Bible or may enhance and/or reinforce the text of Bible scripture 14.

In another alternative exemplary embodiment, Bible scripture 14 may be pre-printed in such a way as to create religious imagery, particularly of the Christian Cross. In another embodiment, device 10 contains Bible scripture 14 to form the shape of a Christian Fish.

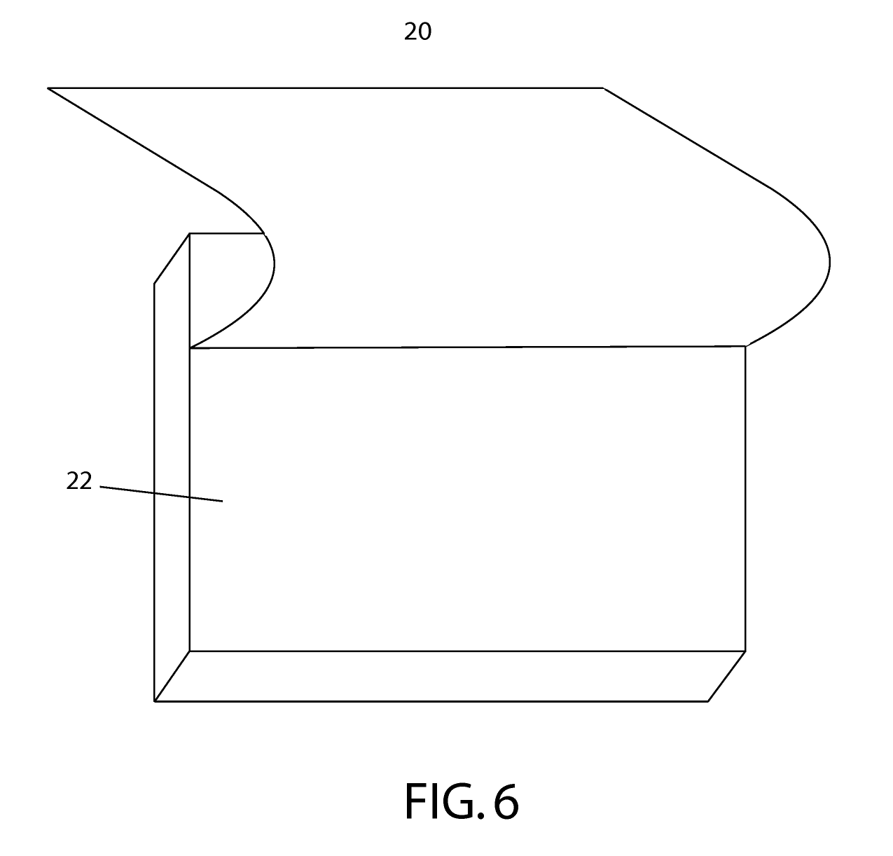

FIG. 6 is a front perspective view of an exemplary embodiment of the present invention depicting device with pre-printed Bible scripture according to the invention.

In an exemplary embodiment, device pad 20 contains blank surface medium 22 without text or imagery. Blank surface medium 22 provides one an opportunity to add additional text from the Bible not included previously in device pad 20.

A device with pre-printed Bible scripture has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching. It is intended that the scope of the invention not be limited by this detailed description, but by the claims and the equivalents to the claims.

What is claimed is:

1. A device with pre-printed Bible scripture comprising:
a generally rectangular medium having straight edges;
a front surface of the medium with a pre-printed Bible scripture; and
a back surface with re-adhesive coating;
wherein, the medium is a particular color based on a theme from the Bible.

2. The device of claim 1, wherein the Bible scripture pre-printed on the front surface of the medium creates an image of a Christian symbol.

3. The device of claim 1, wherein the Bible scripture pre-printed on the front surface of the medium is a circular shape inside the edge of the medium.

4. The device of claim 1, wherein the Bible scripture pre-printed on the front surface of the medium is a rectangular shape inside the edge of the medium.

5. The device of claim 1, wherein the medium further comprises pictorial imagery.

6. A device pad comprising:
a plurality of rectangular mediums having straight edges, wherein each medium comprises;
a pre-printed Bible scripture on the front surface of the medium; and
a back surface with re-adhesive coating on each medium; and
the medium is a particular color based on Bible scripture theme.

7. The device pad of claim 7, wherein the Bible scripture pre-printed on the front surface of the medium creates an image of a Christian symbol.

8. The device pad of claim 7, wherein the Bible scripture pre-printed on the front surface of the medium is a circular shape inside the edge of the medium.

9. The device pad of claim 7, wherein the Bible scripture pre-printed on the front surface of the medium is a rectangular shape inside the edge of the medium.

10. The device pad of claim 7, wherein the medium comprises pictorial imagery.

11. The device pad of claim 7, wherein the medium comprises a blank surface for additional Bible scriptures.

12. A device stack comprising:
a plurality of rectangular mediums having straight edges, wherein each medium comprises;
a pre-printed Bible scripture on the front surface of the medium;
a back surface with re-adhesive coating on each medium; and
the medium is a particular color based on Bible scripture theme;
wherein, said stack includes plurality of colors of mediums with each color representing a particular theme.

13. The device stack of claim 12, wherein the Bible scripture pre-printed on the front surface of the medium creates an image of a Christian symbol.

14. The device stack of claim 12, wherein the Bible scripture pre-printed on the front surface of the medium is a circular shape inside the edge of the device.

15. The device stack of claim 12, wherein the Bible scripture pre-printed on the front surface of the medium is a rectangular shape inside the edge of the device.

16. The device stack of claim 12, wherein the medium comprises pictorial imagery.

17. The device stack of claim 12, wherein the medium comprises a blank surface for additional Bible scriptures.
